(19) United States
(12) Patent Application Publication
(10) Pub. No.: US 2004/0218383 A1
(43) Pub. Date: Nov. 4, 2004

(54) Manually-operated illuminating device

(76) Inventor: Robert T. Bailey III, Lakewood, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/429,242

(22) Filed: May 2, 2003

(51) Int. Cl. F21L 19/00

(52) U.S. Cl. 362/169; 362/109; 362/269

(57) ABSTRACT

A device used as a toy or novelty item has a handle and one or more LEDs that are powered by a stepper motor that is configured to operate as a generator. The stepper motor is embedded within a protective housing element and is rotatably connected with the handle. The housing element extends from the handle and rotates with the stepper motor about the hand-held handle to generate electric current. The LEDs are electrically connected to the stepper motor and extend along the housing element. The device may be used as a hand-held toy so that the LEDs illuminate when the element is twirled or spun relative to the handle. The device may also be used as the handle of a jump rope. When the jump rope is twirled or spun between the handles, the stepper motors generate current which illuminates the LEDs to create an entertaining effect.

### FIELD OF THE INVENTION

The present invention relates to a device that contains one or more light elements, and particularly to hand-held toys and novelty items that incorporate a generator, such as a stepper motor, for illuminating one or more light elements, such as light emitting diodes, by the manual rotation of one or more parts of the toy or novelty item.

### BACKGROUND

A variety of mass-produced toys and novelties feature diodes or other light elements that light up to provide an entertaining visual effect. In most cases, the toys require one or more batteries to produce the output voltage needed to illuminate the light element. An obvious drawback to battery-powered devices is the limited battery charge, which in turn limits the useful life of the device. Toys and novelties that are manufactured with, non-replaceable battery packs are typically discarded once their battery packs expire. Toys and novelties that are powered by replaceable batteries can be used indefinitely, but still consume batteries that require proper disposal.

### SUMMARY OF THE INVENTION

In accordance with the present invention, a manually operated hand-held illuminating device is provided. The device includes an electrical generator having a rotatable shaft. The electrical generator may be provided in the form of a stepper motor configured to operate as a generator. A handle having an attachment end is connected with the rotatable shaft of the generator to hold the handle in fixed position relative to the shaft to enable the generator to rotate relative to the handle and the shaft. The handle may be affixed to the shaft to enable the generator to be rotated about the shaft and rotated relative to the handle. An eccentric element is supported relative to the electrical generator and is configured with the generator to rotate about the shaft and to rotate relative to the handle. In use, the handle may be hand held by a user and manually moved to spin the generator and the eccentric element about the shaft to generate electric current. At least one light emitting diode is electrically connected with the generator for illumination by the electric current generated by the generator as the generator is spun around the shaft and the handle by a user. The eccentric element may include a decorative element when the device is used as a handheld toy. The decorative element may include a face member that is illuminated by the light emitting diode or by a plurality of such diodes. The face member may also include indicia such as marking indicia, for example, in the form of a name imprinted or formed on the face member. Alternatively, the eccentric element may include at least the end of a rope that can be spun around the handle such as for use as a jump rope.

The illuminating device may include a protective housing for the generator. The housing may comprise an encasement element with the generator embedded within the encasement element. The eccentric element may be connected with the encasement element or may be an integral piece with the eccentric element. The light emitting diodes may be arranged to illuminate both the encasement element and the eccentric element or either one of them. The light emitting diodes may be embedded within either or both of the encasement and the eccentric elements in any desired configuration.

In a specific configuration, the present invention provides an inexpensive toy or novelty device that may be used almost indefinitely and does not require battery power. The device has a handle attached to the shaft of a stepper motor configured to operate as an electrical generator. A plurality of lamps or lightemitting diodes (LEDs) are electrically connected to the stepper motor and are illuminated in response to electrical pulses generated by the stepper motor. For this purpose, an eccentric element extends from the stepper motor and rotates with the stepper motor on the shaft as the stepper motor and the eccentric element are twirled about the handle by the user to generate electrical pulses. The LEDs are arranged along the eccentric element and illuminate when the eccentric element is rotated relative to the handle. The eccentric element may comprise a variety of decorative elements or marking indicia that are illuminated by the LEDs.

In another embodiment of the invention, the device may be used as an illuminated rope toy, such as a jump rope. The illuminated rope toy includes a first handle having an attachment end. A first generator is provided having a shaft connected to the attachment end of the first handle to hold the handle in fixed position relative to the shaft to enable the generator to be rotated about the shaft and rotated relative to the handle. A first housing containing the generator is rotatable with the generator about the shaft to enable the generator to generate electric current. A rope having a first end is connected with the first housing in a configuration so that the handle may be hand held by a user and manually moved to spin the housing and the end of the rope about the shaft causing the generator to rotate about the shaft to generate the electric current. At least one light emitting diode is electrically connected to the generator for illumination by the electric current. The housing may include an encasement element having the generator embedded within the encasement element. The light emitting diode or a plurality of such diodes may illuminate the encasement element or a light section of the encasement element as the rope and generator are spun around the handle by the user. The LEDs may be embedded within the encasement element or within the light section of the encasement element. The LEDs may also be optionally disposed along the rope or embedded or housed within a flexible tube that serves as the rope or as a section of the rope. A buffering liquid or gel may be contained within the tube so that the LEDs float within the liquid or gel to buffer shock to the LEDs. Optionally, the rope toy may include a second handle having an attachment end and a second generator having a shaft connected to the attachment end of the second handle to hold the second handle in fixed position relative to the shaft of the second generator to enable the second generator to be rotated about the shaft of the second generator and rotated relative to the second handle. A second housing containing the second generator is rotatable with the second generator about the shaft of the second generator to enable the second generator to generate electric current. A second end of the rope is connected with the second housing in a configuration so that the second handle may be hand held by the user and manually moved to spin the second housing and the second end of the rope about the shaft of the second generator causing the second generator to rotate about the shaft of the second generator to generate the electric current. At least one light emitting diode is electrically connected to the second generator for illumination by the electric current produced by the second generator.

In a specific configuration, the rope toy has a first handle affixed to the rotatable shaft of a stepper motor which operates as an electrical generator. The rope toy also has a second handle affixed to the rotatable shaft of a second stepper motor. A housing is mounted on each stepper motor and contains a plurality of LEDs electrically connected to the respective stepper motors. The housings are rotatable with the stepper motors to generate electrical pulses that illuminate the LEDs. A rope or line is connected between the housings on the first and second handles. When the rope is twirled or spun between the first and second handles, the first and second ends of the rope cause the housings and stepper motors on the first and second handles to rotate, generating electrical pulses that illuminate the LEDs to create an entertaining effect.

### DESCRIPTION OF THE DRAWINGS

The foregoing summary as well as the following description will be better understood when read in conjunction with the drawing figures in which:

FIG. 1 is a perspective view of a device in accordance with the present invention for use as an illuminated hand held toy.

FIG. 2 is a cross-sectional view of the device of FIG. 1 taken through line 2-2 in FIG. 1.

FIG. 3 is a perspective view of an alternate embodiment of the invention for use as a jump rope having illuminated sections.

FIG. 4 is a partial cross-sectional view of the device of FIG. 3, taken through line 4-4 in FIG. 3.

FIG. 5 is a fragmentary perspective view of an alternate embodiment of the present invention for use as a jump rope with LEDs disposed along the rope element.

FIG. 6 is a partial cross-sectional view of the device of FIG. 5, taken through line 6-6 in FIG. 5.

### DETAILED DESCRIPTION OF THE PREFERRED EMBODIMENT

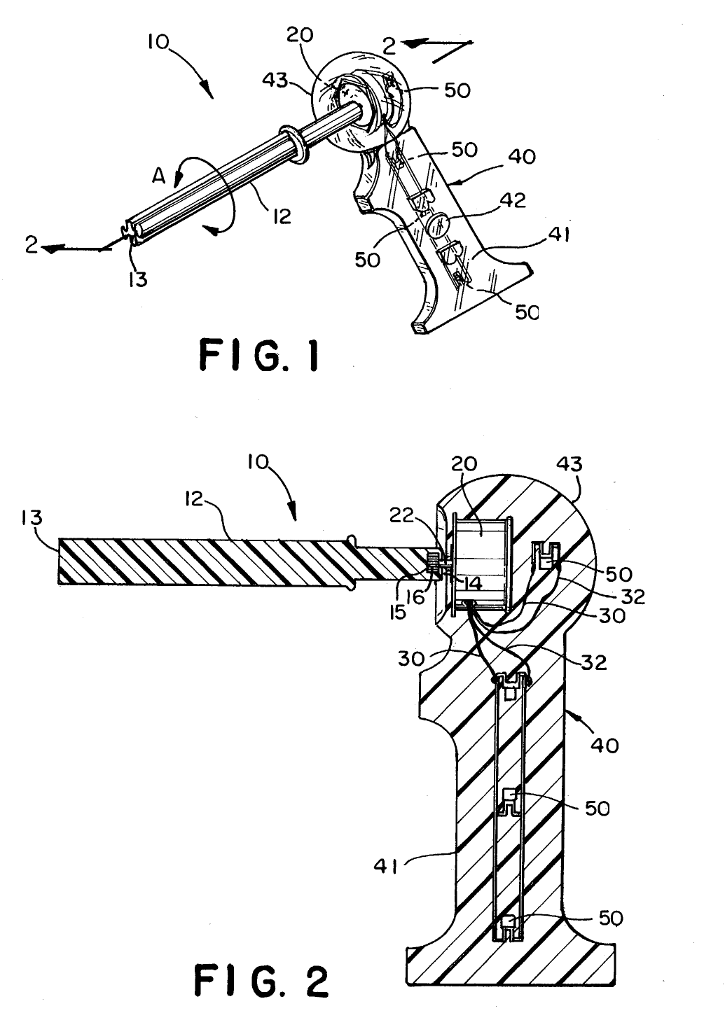

Referring to the drawing figures in general, and to FIG. 1 specifically, a manually operated hand-held illuminating device, generally designated 10, in accordance with the present invention is shown and designated. The device 10 has an elongated handle 12 and a spin element 40 rotatably mounted relative to the handle configured for use with a variety of items, including toys, key chains, party favors, or other novelty items. The spin element 40 is rotatably mounted on one end of the handle 12 and has a plurality of small lamps or light sources 50 arranged relative to the spin element 40. When the spin element 40 is rotated relative to the handle, the lights 50 illuminate the spin element to provide an amusing or entertaining effect. In use, a user manually grasps the handle and then manipulates the handle to cause the spin element to twirl about the handle. The rotation of the spin element 40 about the handle causes a small electric generator 20 housed within the spin element to generate an electric current to illuminate the light sources 50.

A variety of lights can be used with the present invention. In FIGS. 1 and 2, the device 10 is shown with a plurality of LEDs 50 which serve as the light sources for the device. The LEDs 50 are illuminated by a stepper motor 20 that is configured to operate as an electric generator to produce a suitable electrical output voltage and current. The stepper motor 20 is rotatably mounted on a shaft 22 connected to the handle 12. The shaft 22 is typically the conventional shaft of the stepper motor. The handle 12 has a first end 13 that is configured to be grasped by the user, and a second end 14, that functions as an attachment end, that connects with the shaft 22. The shaft 22 and handle 12 are joined with one another so that the shaft is held in fixed position relative to handle so that the shaft and handle may rotate as a unit.

The shaft 22 and handle 12 may be joined by a pressure fit connection, bonding, or other rigid connection. In FIG. 2, for example, the second end 14 of the handle 12 is formed with a small recess 15. The recess 15 contains a base gear 16 mounted in fixed position of the free end of the shaft 22 of the stepper motor 20. The base gear is typically the conventional motor gear mounted on the shaft of the stepper motor. The base gear 16 is mounted within the recess 15 of the handle 12 in a fixed position relative to the handle 12. The base gear 16 may be fixed in the recess 15 of the handle 12 by using a bonding agent, such as an epoxy, or by a direct engagement with the walls of the recess 15 that prevents rotation of the base gear in the recess. The handle 12 is mounted on the base gear so that the shaft 22 extends outwardly from the handle along the longitudinal axis of the handle.

The stepper motor 20 is rotatable relative to the shaft 22 and the handle 12 to generate an output voltage. A pair of wires 30, 32 extend from the stepper motor 20 and connect to the LEDs 50 which are arranged in parallel on the spin element 40. Pulses of current generated by the rotating stepper motor 20 illuminate the LEDs. The stepper motor 10 must produce sufficient milliamps of current to illuminate the LEDs 50. The particular motor selected depends on several variables related to the use and construction of the device. For example, a 1.8 volt motor providing 0.200 milliamps of current and having a winding resistance of 120 ohms may be sufficient for many applications. Higher or lower output voltages and currents can also be used as needed.

The spin element 40 is mounted eccentrically on the shaft 22 to provide an eccentric element 41 relative to the shaft to enable the spin element to whirl around the handle through the manual manipulation of the handle by the user. That is, the spin element 40 has a center of gravity that is offset from the longitudinal axis of the handle 12, so that a majority of the element's weight is distributed on one side of the handle. The spin element 40 is connected with the stepper motor 20 so that the element and motor are rotatable in unison about the longitudinal axis of the handle 12. The spin element 40 includes an encasement section 43 that serves to house and protect the stepper motor 20. As shown in FIGS. 1 and 2, the stepper motor may be embedded within the encasement section of the spin element 40. The eccentric element 41 is connected with the encasement section and may optionally be formed as an integral unit with the encasement section. The eccentric element 41 may extend from the encasement section 43 generally radially outward relative to the shaft of the stepper motor to provide the desired offset weighting. By imparting rotational force on the spin element 40, the spin element 40 and the stepper motor 20 are rotated about the axis of the handle to generate an output voltage. The spin element can be made from a suitable material, such as a resinous material, to house and protect the stepper motor and the LEDs.

To generate output voltage from the stepper motor 20, the handle 12 is grasped and shaken by the user to spin or twirl the spin element 40 in a rapid gyrating fashion. Alternatively, the spin element 40 may be held in a stationary position while the handle 12 is rotated to create relative rotation between the element 40 and the handle 12. Referring to FIG. 1, the handle 12 may be rotated about its axis in the directions shown by arrow “A” or the spin element 40 may rotate about the handle in the directions shown by arrow “A”. In either case, the stepper motor 20 generates pulses of electrical current that are transmitted through the wires 30, 32 to the LEDs 50 in order to illuminate the LEDs as the spin element 40 is rotated relative to the handle 12.

The eccentric element 41 may also serve as or provide a decorative element having one or more face surfaces or face members on which the LEDs 50 are arranged. As shown in FIGS. 1 and 2, the faces of the eccentric element 41 having marking indicia 42 are disposed generally parallel to the shaft 22 of the stepper motor. The LEDs may be arranged on or along either or both the eccentric element 41 and the encasement section 43 to illuminate either or both the eccentric element and the encasement section. The LEDs may be housed within the eccentric element or the encasement section and may be directly embedded therein. To effect suitable illumination, the spin element 40 may be made from a transparent or translucent material to permit the enclosed LEDs to illuminate light therethrough. The LEDs may be arranged to illuminate the face surfaces or face members of the eccentric element. In addition to the LEDs 50, it may be desirable to display marking indicia 42 on the device 10. For example, a face of the eccentric element 41 may contain a marking design or indicia imprinted or formed onto the face. The indicia may be etched or cut into the face or formed as raised relief on the face. In addition, the spin element 40 may be molded or constructed to form a decorative eccentric element 41 with a recognizable shape. In FIG. 1, the face of element 41 displays selected marking indicia 42 that identify a person's name. The indicia 42 are positioned over the LEDs 50 such that the indicia are illuminated by the LEDs when the LEDs are powered by the stepper motor. The spin element 40 also has a shape generally resembling an Arabic numeral.

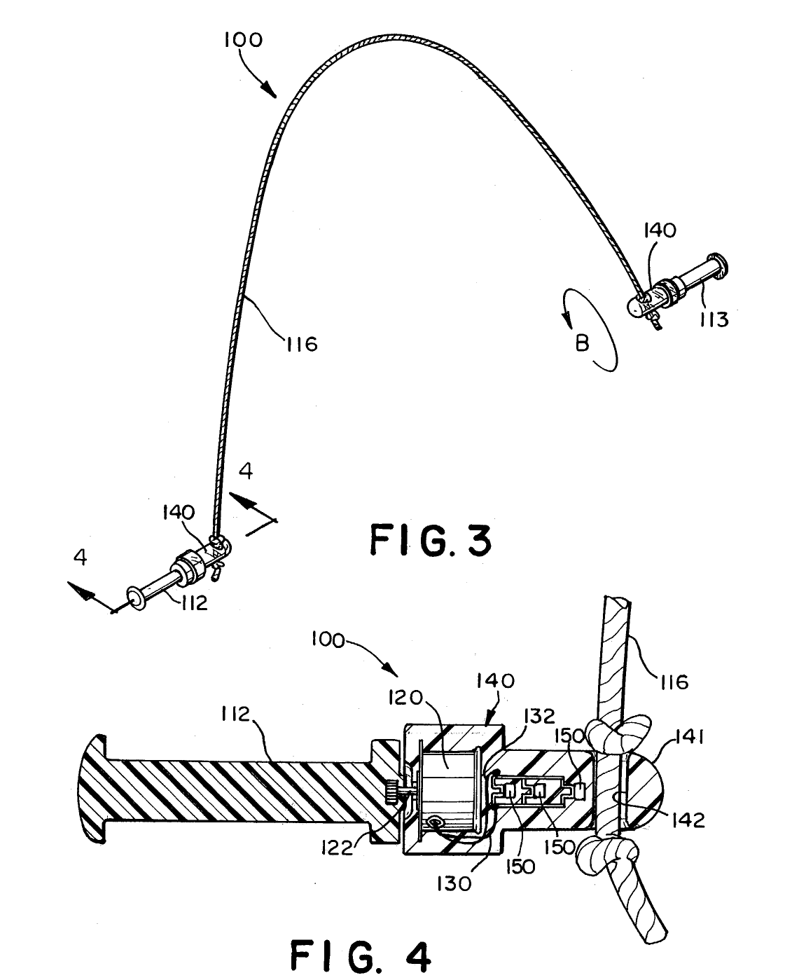

Referring to FIGS. 3 and 4, an alternate embodiment of the hand-held illuminating device, generally designated 100, in accordance with the present invention is depicted for use in a child's jump rope. The rope toy devicel 00 is similar in construction and operation to the hand-held device shown in FIGS. 1 and 2. The device 100, has a first handle 112 and a second handle 113 which is substantially identical to the first handle. The handles 112, 113 are joined by a rope element 116, which may be formed of a variety of materials suitable in children's rope toys. A housing 140, which serves as a spin element, is rotatably connected to each handle. The housings 140 contain a plurality of LEDs 150 that illuminate when the toy is in use.

The housings 140 are formed with a transparent or translucent durable material, such as a molded resinous material, so that the LEDs are visible through the walls of the housings. Each housing 140 forms a central encasement element that provides a chamber that contains or embeds a stepper motor 120 and a plurality of LEDs 150 to illuminate the encasement section. The LEDs may be positioned at other desired locations. For example, the encasement element may include a separate or integral light section 141 that contains or mounts the LEDs. The light section may have a desired decorative shape and may also include marking indicia. If desired, the LEDs may also extend along the rope or a portion of the rope. Each stepper motor 120 is connected to the LEDs by a pair of wires 130, 132. The stepper motors 120 have rotatable shafts 122 that are connected to the handles 112, 113 in the same general manner described with respect to the first embodiment, described above. As such the shaft of the stepper motor extends from the handle generally along the longitudinal axis of the handle. The housings 140 are integrally connected to the stepper motors 120 so that the housings and motors are rotatable in unison about the respective shafts and handles. By imparting rotational force on the housings 140 through the manual manipulation of the handles, the housings and stepper motors 120 are rotated relative to the handles 112, 113, generating output voltages that power the LEDs 150.

The rope 116 has a pair of ends, with each end connected to one of the housings 140 on handles 112, 113. The rope 116 is displaceable between the handles 112, 113 to impart rotational force on the housings 140 and operate the stepper motors 120. The rope ends may be removably or permanently connected to the handles 112, 113 in a variety of ways to facilitate translation of torque to the housings 140. As such the rope ends function as eccentric elements to help effect rotation of the housings and the stepper motors about the shafts and handles. Referring to FIG. 4, the.connection between the rope 116 and handle 112 is shown. The connection for handle 112 is generally the same as that used to connect the rope 116 to handle 113. Housing 140 has a bore 142 that receives an end the rope 116. The end of rope 116 has a slightly. smaller diameter than the diameter of the bore 142, permitting the rope end to be inserted through the bore and knotted at two locations on both sides of the bore through the housing 140. The bore142 extends through the housing 140 generally perpendicular to the axis of the housing and handle 112. As such, the rope 116 extends through the housing 140 in an angular orientation that may be generally perpendicular to the handle 112 and generally perpendicular to the axis of the shaft of the stepper motor.

Referring again to FIG. 3, the LEDs 150 may be illuminated by grasping the two handles 112, 113 and twirling or spinning the rope 116 between the handles in the direction indicated by arrow “B”. As the rope 116 is twirled, the ends of the rope cause the housings 140 and stepper motors 120 to rotate relative to the handles 112, 113. Rotation of the stepper motors 120 generates output voltages and electrical currents that power the LEDs in each housing 140.

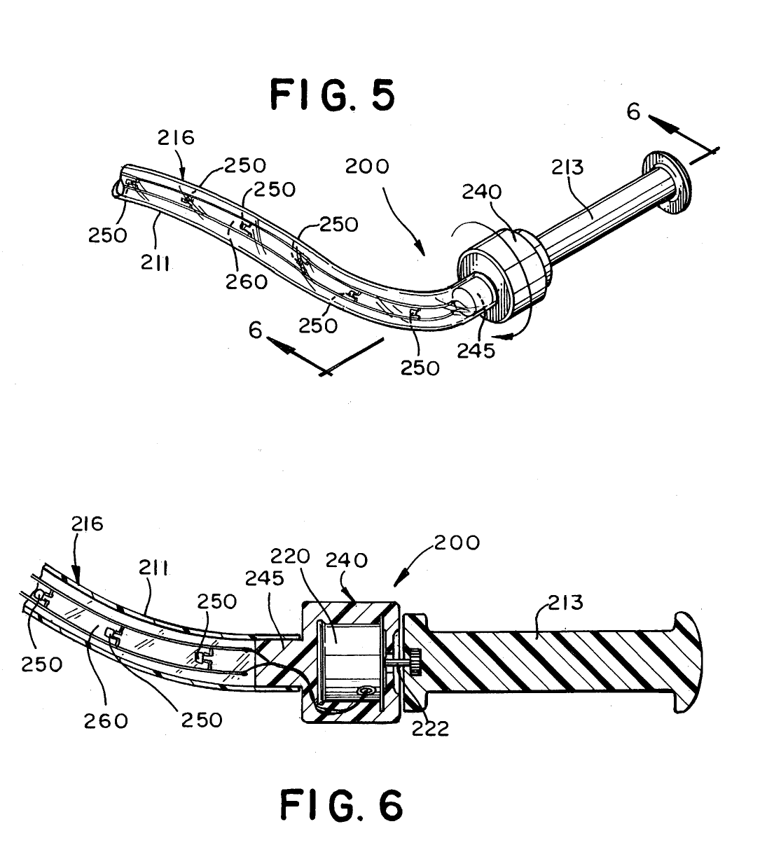

As shown in FIGS. 5 and 6, a jump rope device, generally designated 200, is depicted. The jump rope device 200 is similar to the jump rope 100 shown in FIGS. 3 and 4 except that the LEDs 250 are disposed within an elongated, flexible transparent or translucent tube 211 that serves as a jump rope 216. The tube 211 is connected to the housing 240 for the stepper motor 220. For this purpose, one end of the tube is slipped over the outer periphery of a generally cylindrical flange plug 245 on the housing 240 and affixed in place, for example, by a suitable adhesive. Tube 211 is made from a suitable flexible material such as a resinous material that can withstand impact with the ground when the device is used as a jump rope 216. The material of the tube 211 should also be somewhat translucent or transparent to permit the transmission of light from the LEDs 250 contained witin the tubing 211. The tubing 211 may be filled with a shocking absorbing liquid or gel 260 to cushion and protect the LEDs to reduce shock to the LEDs during use. The shock absorbing liquid should also be translucent or transparent to enable the transmission of light from the LEDs contained within the liquid within the tube 211. To prevent leakage of the shock absorbing liquid from the tube 211, the tubular end of the tube 211 must be sealed relative to the cylindrical flange plug 245. Sparkles or glitter elements may be suspended in the shock absorbing liquid to reflect the light from the LEDs disposed within the tubing 211.

A handle 213 for the jump rope device 200 is mounted on a shaft 222 of the stepper motor 220 to enable the rope 216 and the housing 240 containing the stepper motor 220 to be manually twirled or spun about the shaft 232 and the handle 213 by the manual manipulation of the handle 213. The spinning of the rope 216 about the handle 213 causes the stepper motor 220 to function as an electrical generator to illuminate the LEDs 250 electrically connected with the stepper motor 220. A second handle 213 may be similarly connected to the other end of the tube to illuminate a second set of LEDs. The LEDs may extend along the length of the rope 216 or along a selected segment or segments of the rope to create an interesting illumination effect during use of the jump rope.

The terms and expressions which have been employed are used as terms of description and not of limitation. There is no intention in the use of such terms and expressions of excluding any equivalents of the features shown and described or any portions thereof. It is recognized, therefore, that various modifications are possible within the scope and spirit of the invention. Accordingly, the invention incorporates variations that fall within the scope of the following claims.

What is claimed is:

1. A manually operated hand-held illuminating device comprising:
A. an electrical generator having a rotatable shaft;
B. a handle having an attachment end connected with the rotatable shaft to hold the handle in fixed position relative to the shaft to enable the generator to be rotated about the shaft and rotated relative to the handle;
C. an eccentric element supported relative to the electrical generator and configured with the generator to rotate about the shaft relative to the handle so that the handle may be hand held and manually moved to spin the generator and the eccentric element about the shaft to generate electric current; and
D. at least one light emitting diode electrically connected with the generator for illumination by the electric current.

2. The illuminating device of claim 1, wherein the eccentric element comprises a face, and wherein the diode is arranged along the face to illuminate the face when the eccentric element is rotated relative to the handle.

3. The illuminating device of claim 2, wherein the face comprises indicia.

4. The illuminating device of claim 2, wherein the at least one light emitting diode comprises a plurality of light emitting diodes arranged along the face.

5. The illuminating device of claim 1 comprising a protective housing for the electrical generator.

6. The illuminating device of claim 5, wherein the protective housing includes an encasement element and the electrical generator is embedded within the encasement element.

7. The illuminating device of claim 6, wherein the eccentric element is connected with the encasement element.

8. The illuminating device of claim 7, wherein the eccentric element includes a decorative element.

9. The illuminating device of claim 7, wherein the eccentric element includes a rope.

10. The illuminating device of claim 7, wherein the eccentric element is integral with the encasement element.

11. The illuminating device of claim 7, wherein the eccentric element includes a face member and the diode is disposed along the face member to illuminate the face member.

12. The illuminating device of claim 11, wherein the face member includes selected marking indicia.

13. The illuminating device of claim 7, wherein the eccentric element includes a face member and the at least one light emitting diode includes a plurality of diodes that are disposed within the encasement element and the face member to illuminate the encasement element and the face member.

14. The illuminating device of claim 1, wherein the handle is elongated and the shaft extends from the handle along the longitudinal axis of the handle.

15. The illuminating device of claim 14, wherein the eccentric element extends radially outward relative to the shaft of the generator.

16. The illuminating device of claim 15, wherein the eccentric element includes a face disposed generally parallel to the shaft.

17. The illuminating device of claim 16, wherein the face includes selected marking indicia.

18. The illuminating device of claim 15, wherein the light emitting diode is disposed to illuminate the face.

19. A manually operated hand-held illuminating device comprising:
A. an electrical generator having a rotatable shaft;
B. an elongated handle having an attachment end connected with the rotatable shaft to hold the handle in fixed position relative to the shaft to enable the generator to be rotated about the shaft and rotated relative to the handle, the handle extending from the shaft generally along the longitudinal axis of the shaft;
C. an encasement element for housing and protecting the electrical generator;
D. an eccentric element supported relative to the encasement element and configured with the generator to rotate about the shaft and relative to the handle so that the handle may be hand held and manually moved to spin the generator and the eccentric element about the shaft to generate electric current, the eccentric element including a face member extending outwardly relative to the handle; and
E. at least one light emitting diode electrically connected with the generator for illumination by the electric current to illuminate the face member.

20. The illuminating device of claim 19, wherein the at least one light emitting diode includes a plurality of light emitting diodes that are disposed to illuminate the face member.

21. The illuminating device of claim 20, wherein the light emitting diodes are disposed within the encasement element and the face member to illuminate the encasement element and the face member.

22. The illuminating device of claim 19, wherein the face member includes a face surface oriented generally parallel to the longitudinal axis of the shaft.

23. The illuminating device of claim 22, wherein the face member includes selected marking indicia on the face surface and the light emitting diode is disposed to illuminate the face member.

24. The illuminating device of claim 23, wherein the at least one light emitting diode includes a plurality of light emitting diodes that are disposed to illuminate the face member.

25. The illuminating device of claim 24, wherein the light emitting diodes are disposed within the encasement element and the face member to illuminate the encasement element and the face member.

26. The illuminating device of claim 19, wherein the face member is configured as a decorative element.

27. The illuminating device of claim 26, wherein the face member is fixed to the encasement element and projects outwardly from the encasement element.

28. The illuminating device of claim 27, wherein the face member is integral with the encasement element.

29. The illuminating device of claim 19, wherein the generator includes a stepper motor.

30. An illuminated rope toy, comprising:
A. a first handle having an attachment end;
B. a first generator having a shaft connected to the attachment end of the first handle to hold the handle in fixed position relative to the shaft to enable the generator to be rotated about the shaft and rotated relative to the handle;
C. a first housing containing the generator and rotatable with the generator about the shaft to enable the generator to generate electric current;
D. a rope having a first end connected with the first housing in a configuration so that the handle may be hand held and manually moved to spin the housing and the end of the rope about the shaft causing the generator to rotate about the shaft to generate the electric current; and
E. at least one light emitting diode electrically connected to the generator for illumination by the electric current.

31. The illuminated rope toy of claim 30 comprising:
A. a second handle having an attachment end;
B. a second generator having a shaft connected to the attachment end of the second handle to hold the second handle in fixed position relative to the shaft of the second generator to enable the second generator to be rotated about the shaft of the second generator and rotated relative to the second handle;
C. a second housing containing the second generator and rotatable with the second generator about the shaft of the second generator to enable the second generator to generate electric current;
D. the rope having a second end connected with the second housing in a configuration so that the second handle may be hand held and manually moved to spin the second housing and the second end of the rope about the shaft of the second generator causing the second generator to rotate about the shaft of the second generator to generate the electric current; and
E. at least one light emitting diode electrically connected to the second generator for illumination by the electric current produced by the second generator.

32. The illuminated rope toy of claim 30, wherein the first housing includes an encasement element and the electrical generator is embedded within the encasement element.

33. The illuminated rope toy of claim 32, wherein the diode is disposed to illuminate the encasement element.

34. The illuminated rope toy of claim 33, wherein the at least one light emitting diode includes a plurality of light emitting diodes.

35. The illuminated rope toy of claim 30, wherein the first generator includes a stepper motor.

36. The illuminated rope toy of claim 30, wherein the first handle is elongated and the shaft extends from the handle along the longitudinal axis of the handle.

37. The illuminated rope toy of claim 36, wherein the first end of the rope extends from the first housing at an angle relative to the shaft of the first generator.

38. The illuminated rope toy of claim 37, wherein the first end of the rope extends generally radially outward from the housing relative to the shaft of the first generator.

39. The illuminated rope toy of claim 30 wherein the rope includes an elongated flexible, light-transmitting tube and wherein the at least one light emitting diode is disposed within the tube.

40. The illuminated rope toy of claim 39 wherein the at least one light emitting diode includes a plurality of light emitting diodes disposed within the tube.

41. The illuminated rope toy of claim 39 comprising a liquid contained within the tube and wherein the at least one light emitting diode is disposed within the liquid within the tube.

42. The illuminated rope toy of claim 41 wherein the at least one light emitting diode includes a plurality of light emitting diodes disposed within the liquid within the tube.

43. The illuminated rope toy of claim 42 comprising light-reflection sparkles disposed within the liquid.

44. The illuminated rope toy of claim 39 wherein the housing includes a flange plug and the first end of the rope includes a tubular end of the tube for insertion over the flange plug.
